(19) United States
(12) Patent Application Publication
(10) Pub. No.: US 2010/0169972 A1
(43) Pub. Date: Jul. 1, 2010

(54) SHARED REPOSITORY OF MALWARE DATA

(75) Inventors: Chengi Jimmy Kuo, Manhattan Beach, CA (US); Marc Seinfeld, Fort Lauderdale, FL (US); Jeff Williams, Seattle, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/347,103

(22) Filed: Dec. 31, 2008

(51) Int. Cl. G06F 21/00; G06F 17/00

(52) U.S. Cl. 726/23; 707/E17.001

(57) ABSTRACT

Various principles for maintaining a shared repository of authorization scanning results, which may be populated with results of authorization scans of particular files (and other content units) as well as a signature for those particular files. When a particular file is to be scanned by a client computing device to determine whether it contains unauthorized software, a signature for the file may be calculated and provided to the shared repository. If the repository has a result for that file—as indicated by a signature for the file being present in the repository—the result in the repository may be provided to the client computing device that issued the query, and the client computing device may accept the answer in the shared repository. If the result is not in the repository (i.e., the file has not been scanned), then the file may be scanned, and a result may be placed in the repository.

### BACKGROUND OF INVENTION

Computing devices of various types may be susceptible to attack. These attacks may take the form of disabling the computing device (e.g., preventing it from functioning in any way, or preventing it from performing a specific function), taking control of the computing device (e.g., forcing it to perform one or more operations that an authorized user of the computing device does not intend it perform), taking information from the computing device (e.g., taking information from a hard disk drive, or logging input by a user such as a password), and a number of other forms.

One way that attacks on a computing device are commenced is through the use of malicious software, or “malware.” Malware may be any software usable to perform an attack on a computing device. Computer viruses are a form of malware. A computer virus is a piece of software code that, once installed on an “infected” computing device, can attach itself to files leaving the infected computing device (e.g., a file stored on a disk, or transmitted via e-mail) without knowledge of its user, and infect other computing devices that access the files. Computer viruses are not, however, the only form of malware; it may take a number of other forms. Other forms of malware include spyware, which monitors operations executed on an infected computing device, including information processed, and reports the operations/information to an outside party; adware, which displays unrequested advertisements to users of an infected computing device; computer worms, which are similar to computer viruses but can replicate themselves to another computing device without a host such as a file; trojan horses, which is malware typically embodied in content that appears innocent but includes malicious code that performs an attack; rootkits, which are designed to gain administrative access to the computing device for themselves, and possibly an outside party (e.g., the attacker) controlling them; and financial attack malware (sometimes termed “crimeware”), which may be used to carry out crimes such as financial and/or identity theft by, for example, detecting when a user is legitimately accessing his or her financial resources (e.g., through the web portal of the user's bank or other financial institution) and then performing illegitimate operations in the background such as issuing instructions to transfer funds to an attacker's bank account.

Malware often infects a computing device and performs its attack when a user accesses a file that carries the malware (typically without knowledge that the file contains malware), thereby triggering execution of the malware embedded in the file and allowing it to carry out the attack. As malware may be embedded in any type of file, accessing the malware may be done in any of various ways, including executing a file (e.g., executing an executable binary), opening a file for read or read/write access in a program (e.g., opening an image file in an image file viewer), or other file operations.

Because of the risk of infection from malware, many computing devices now use software that aims to detect malware before it is accessed and an attack triggered. The software detects malware by scanning files upon request by a user, or by detecting when an operation is to be performed that accesses a file, intervening in the operation, and delaying that operation until a scan can be completed to determine if malware is present. Malware scanning software on a computer may maintain a local data store of sets of file characteristics for each of a plurality of files, and an indication of whether files that match a given set of file characteristics include or do not include malware. The malware scanning software may determine file characteristics for a file to be scanned, and then compare the determined file characteristics to the sets of predefined characteristics. If the characteristics indicate that the file includes malware, then the malware scanning software may inform the user and/or block access to the file. The local data store of file characteristics may be periodically updated to identify new malware developed and released by attackers. This update may be done by a vendor of malware scanning software.

### SUMMARY OF INVENTION

Conventionally, malware scanning software is maintained and executed locally on a computing device, and scans content units, such as files, to be stored or accessed locally on that computing device. This requires that the computing device have storage space to maintain a data store of sets of file characteristics, storage space to maintain the malware scanning software itself, and processing power to execute the malware scanning software quickly and efficiently so as to minimize disruption to the user during scanning.

Applicants have appreciated that some files may have copies on many different computing devices, and may be being scanned and used at each of those computing devices. Accordingly, each computing device scanning a particular file may achieve the same result for the file, duplicating the work of other computing devices.

Applicants have appreciated that greater efficiency in performing scanning for unauthorized software, such as malware, may be achieved by forming a community of computing devices, each of which shares results of authorization scans (e.g., malware scans)) with other computing devices. Each of these other computing devices may rely on the results of previous scans performed, and thus be freed from the burden of performing a scan itself on every file to be accessed. Instead, a particular computing device may, in some embodiments, only be required to perform a scan of a file when the particular computing device is the first to access the file, including when the file is unique to that computing device. The computing device may then provide the result of the scan to other computing devices in the community, such that they may benefit from the work performed by the particular computing device.

A community of computing devices sharing authorization scanning results may also be beneficial in that computing devices that are unable to carry out authorization scans—such as due to lack of necessary storage and/or processing requirements—may make use of the results of other computing devices. These computing devices that could not perform an authorization scan may previously have been open to attack as a result of this deficiency, but now may have at least some form of protection from threat by participating in the community.

Described herein are various principles for maintaining a shared repository of authorization determinations, which may be populated with results of authorization scans of particular files (and other content units) as well as a signature for those particular files. In one embodiment, when a particular file is to be scanned by a client computing device to determine whether it includes unauthorized software, a signature for the file is calculated and provided to the shared repository. If the repository has a result for that file—as indicated by a signature for the file being present in the repository—the result in the repository is provided to the client computing device that issued the query, and the client computing device accepts the answer in the shared repository. If the result is not in the repository (i.e., the file has not been scanned), then the file is scanned, and a result is placed in the repository.

In one embodiment, there is provided a method for making a determination of whether a particular content unit to be accessed in a computer system contains unauthorized software. The computer system comprises at least two client computing devices and a shared repository of authorization determinations. The shared repository of authorization determinations is accessible to each of the at least two client computing devices and comprises results of authorization determinations. Each authorization determination includes a determination of whether a corresponding content unit contains unauthorized software. At least some of the authorization determinations were made by one or more of the at least two client computing devices. The method comprises providing a unique identifier for the particular content unit to the shared repository of authorization determinations, receiving an indication of whether the shared repository includes an authorization determination for the particular content unit, and, if the shared repository includes an authorization determination for the particular content unit, using the authorization determination in the shared repository to inform access to the particular content unit.

In another embodiment, there is provided at least one computer-readable medium encoded with computer-executable instructions that, when executed by a computer, cause the computer to carry out a method. The method is for making a determination of whether a particular file to be accessed in a computer system contains malicious software. The computer system comprises at least two client computing devices and a shared repository of malware determinations. The shared repository of malware determinations is accessible to each of the at least two client computing devices and comprises results of malware determinations. Each malware determination includes a determination of whether a corresponding file contains malicious software. At least some of the malware determinations were made by one or more of the at least two client computing devices. The method comprises providing a unique identifier for the particular file to the shared repository of malware determination results and receiving an indication of whether the shared repository includes a malware determination for the particular file. The method further comprises, if the shared repository includes a malware determination for the particular file, using the malware determination in the shared repository to inform access to the particular file. The method further comprises, if the shared repository does not include a malware determination, determining whether the particular file contains malicious software and updating the shared repository with a result of the determining.

In a further embodiment, there is provided a first client computing device for use in a computer system comprising the first client computer, at least one second client computing devices and a shared repository of authorization determinations. The shared repository of authorization determinations is accessible to each of the at least two client computing devices and comprising results of authorization determinations. Each authorization determination includes a determination of whether a corresponding content unit contains unauthorized software. At least some of the malware determinations were made by one or more of the at least two client computing devices. The first client computing device comprises at least one processor adapted to make a determination of whether a particular content unit to be accessed in the computer system contains unauthorized software. The at least one processor is programmed to do this by providing a unique identifier for the particular content unit to the shared repository of authorization determinations, receiving an indication of whether the shared repository includes an authorization determination for the particular content unit, and, if the shared repository includes an authorization determination for the particular content unit, using the authorization determination in the shared repository to inform access to the particular content unit.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of an exemplary computer system in which some embodiments of the invention may act;

FIG. 2 is a flowchart of an illustrative process for performing a malware scan of a file via a client computing device in some embodiments of the invention;

FIG. 3 is a flowchart of an illustrative process for performing a malware scan of a file via a server maintaining a shared repository of malware scanning results in some embodiments of the invention;

FIGS. 4A, 4B, and 4C are flowcharts of alternative illustrative processes for carrying out malware scans of files that may be implemented by client computing devices and/or servers in some embodiments of the invention;

FIGS. 5A and 5B are flowcharts of illustrative processes for determining, on a client computer device, whether to query a shared repository of malware scanning results based on characteristics of a file to be scanned;

FIG. 6 is a flowchart of an illustrative process for determining, on a server, whether to flush the contents of a shared repository of malware scanning results based on one or more exemplary conditions;

FIG. 7 is a flowchart of an illustrative process for determining, on a server, whether any files associated with entries stored in a shared repository of malware scanning results are popular files;

FIGS. 8A and 8B are flowcharts of illustrative processes for automatically repopulating a shared repository of malware scanning results when it is detected that the repository has been flushed;

FIG. 9 is an illustration of an alternative computer system in which some embodiments of the invention may act;

FIG. 10 is a block diagram of an exemplary computing device that may act as a client computing device in some embodiments of the invention;

FIG. 11 is a block diagram of an exemplary computing device that may act as an server maintaining a shared repository of malware scanning results in some embodiments of the invention; and

FIG. 12 is a table showing one exemplary format of entries that may be stored in a shared repository of malware scanning data in one embodiment of the invention.

### DETAILED DESCRIPTION

Applicants have recognized and appreciated that performing malware scans of files is a process that is intensive both in terms of the storage space necessary for maintaining the various data sets necessary to enable a scan, and the processing resources necessary to perform the scans. To scan a file to determine whether the file includes malware, a computing device conventionally must have malware scanning software installed on it, which uses storage space on the computing device's storage media. The computing device must further have sets of file characteristics that may be used by the scanning software to determine whether particular files include malware (such sets of file characteristics, defined below, may be referred to below as “malware definitions”), and these sets of file characteristics may use more storage space. Lastly, malware scanning software may have to perform an intensive review of some large files, and so may have large processing power requirements or may drain processing resources (such as processing time) from other computer operations.

Applicants have further recognized and appreciated that some files may have copies on many different computing devices, and may be being scanned and used at each of those computing devices. For example, system files relating to an operating system, application program files associated with popular application programs, and some data files storing information generated by a user or application program may be present on multiple different computing devices. Applicants have further appreciated that requiring each computing device with a copy of the file to perform the same scan is inefficient, and that greater efficiency could be achieved for a community of computing devices if they shared scanning results so that each computing device could leverage scan results that had been previously determined by another computing device.

In addition, some computing devices may not be capable of—or may not be well suited for—executing malware scanning software, for example because they do not have sufficient processing power, storage space, or battery life (other power source) to carry out malware scanning. Traditionally, malware scanning has not been available to such computing devices. However, Applicants have further recognized and appreciated that such computing devices can make use of scanning results that have been previously determined by other computing devices. In this way, the benefits of malware scanning may be provided to some computing devices incapable of performing such scans.

Sharing of malware scanning results may take place in any suitable fashion. Some exemplary processes are laid out below for purposes of illustration, but the aspects of the invention relating to the sharing of malware scanning results are not limited to these particular implementations, as others are possible.

In some embodiments of the invention, a shared repository of malware scanning results may be maintained that stores at least a unique identifier (e.g., a signature) for each of the files in the repository and a result indicating whether each file was determined to include malware. A client computing device may, when it desires to determine whether a particular file contains malware, to provide a unique identifier (e.g., calculate a file signature) for that particular file. The file signature or other unique identifier may then be compared to identifiers in the repository to determine whether another computing device has previously scanned the particular file. If the identifier for the particular file matches an identifier in the repository, then the result associated with the identifier in the repository may be used as the result for the file, alleviating the need for the client to perform a scan. If the identifier for the particular file does not match any identifiers in the repository, then the particular file may be scanned in any suitable manner (e.g., by the client that provided the identifier, by a server that maintains the repository, or by another client in the community of computing devices), examples of which are described below. The result of the scan may then be used by the client computing device that provided the identifier. In some embodiments, the result may also be placed in the repository to make it available to other computing devices in the community. However, not all embodiments of the invention are limited in this respect, as the repository may be populated in other ways. For example, in one embodiment of the invention, a result of a scanning operation for a particular file may only be placed in a repository once it is detected that the particular file has been scanned a threshold number of times by individual computing devices in the community, which may indicate that the file is more likely to be accessed by other computing devices.

In this way, the burden of performing malware scans is lessened, as computing devices may make use of previously-determined results calculated by other computing devices.

It should be appreciated that this is only one example of the ways in which a system acting in accordance with the various principles described herein may operate, and that these principles may be implemented in any of various ways. Other examples are discussed below, though it should be appreciated that these implementations are merely illustrative and that embodiments of the invention may operate in any suitable manner implementing any suitable techniques and processes. Further, all embodiments of the invention need not implement all of the techniques discussed below.

Further, it should be appreciated that malware is one example of unauthorized software. The techniques described herein may be used to perform scans and determinations relating to any kind or type of unauthorized software. Any suitable file may be determined to be unauthorized software based on any suitable criteria. Malware, as one example of unauthorized software, has been described above as including files (or other content units) that are or include computer viruses, trojan horses, computer worms, and other types of harmful files that may carry out attacks on a computing device if those files are accessed. Applicants have appreciated that, in some environments, unauthorized software may also include files that may not be harmful, but have been determined to not be authorized to be accessed on the computing device. Some such files may be considered unauthorized in one environment, but may be authorized in another environment. For example, a corporate policy for a corporate enterprise network may dictate that no computing device may run computer gaming software (for example, to increase productivity of the employees using the computers). In that network (i.e., that environment) then, gaming software may be considered unauthorized software, and an authorization scan may be carried out to determine whether a particular file is associated with a computer game. Similar tests may be carried out for types of files other than gaming, for any suitable file or file type. As another example, an authorization policy may be implemented that determines whether files were provided by a trusted (or untrusted) source. For example, an authorization scan may be carried out to determine whether a file was retrieved from a particular source (e.g., a particular server), or whether a file was signed by an authority considered in the environment to be trusted. A file that was not provided by a trusted source may be considered to be unauthorized.

Accordingly, it should be appreciated that embodiments of the invention are not limited to determining whether particular files contain malware, but rather may be implemented to determine whether files may be unauthorized based on any suitable criteria, including by one or more policies of the environment. Where examples are described below as making determinations for whether a file is or includes malware, it should be appreciated that, unless noted otherwise, those examples apply equally to other types of unauthorized software as well.

For ease of illustration, the example above and the various examples below are described in terms of “files” (e.g., performing a malware scan of a file, or calculating a signature of a file). It should be appreciated, however, that embodiments of the invention are not limited to operating with files or with any computing device that stores information in a file system. Rather, embodiments of the invention may operate with any suitable type or types of content organized in any suitable content unit. For example, malware scans according to the techniques described herein may be performed on streams of data or database entries, or any other type of non-file content. Accordingly, where the examples below reference “files” it should be understood, unless noted otherwise, that those examples apply equally to other types of content as well.

Various operations performed by embodiments of the invention are described in the examples described below with reference to files. For example, in some techniques below a “file signature” may be calculated that is an identifier for a file, including an identifier that is unique or probabilistically unique. However, it should be appreciated that a file signature is only one example of an identifier that may be provided for a file, and that any suitable identifier for a file may be used, unique or otherwise. Further, it should be appreciated that where the examples described below reference a “file signature” for a file, it should be appreciated that for embodiments of the invention that operate with types of content other than files, any suitable technique may be used in those embodiments of the invention for identifying a content unit.

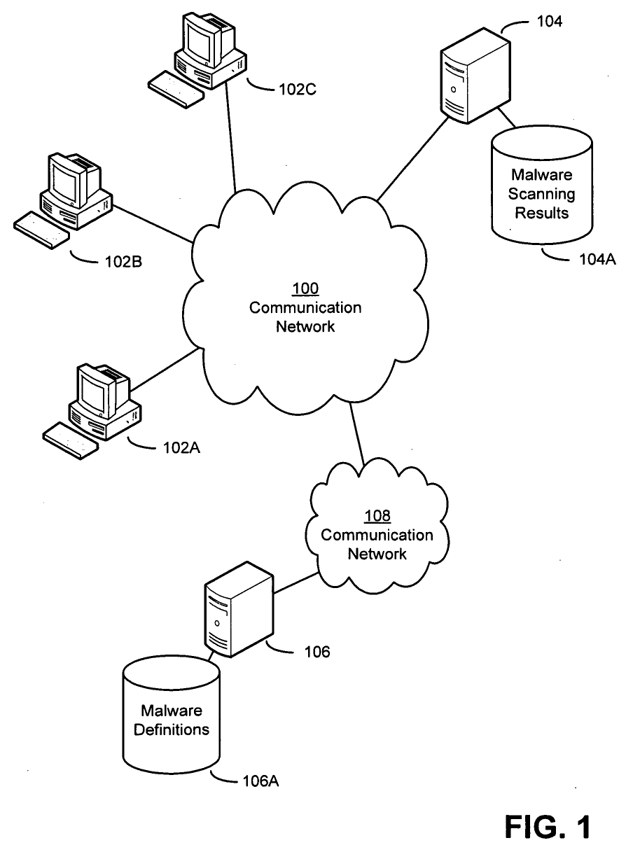

The techniques described herein for sharing the results of malware scans can be implemented in any suitable environment, including on any computer system comprising any number and type(s) of computing devices, as embodiments of the invention described herein are not limited in this respect. FIG. 1 shows one illustrative computer system in which some exemplary implementations of these techniques may act, but it should be appreciated that embodiments of the invention are not limited to being implemented in this or any other particular type of computer system.

FIG. 1 shows a computer system comprising a computer communication network 100 interconnecting a plurality of computing devices such as client computing devices 102A, 102B, and 102C (herein, unless specified, a reference to “computing device 102” should be understood to refer to any one of the computing devices 102A, 102B, and 102C). While three computing devices are shown in the computer system of FIG. 1, it should be understood that the system may include any number of client computing devices. Further, while computing device 102 is shown as a desktop personal computer, in alternative systems it may be any suitable computing device such as a laptop personal computer, a PDA, a smart phone, a server (e.g., a web server), a rack-mounted computer, a networking device such as a router or switch, or any other computing device accessing files (or other content units) and having a desire to verify that the files do not include malware.

Also connected to the communication network 100 is a server 104 maintaining a repository 104A of malware scanning results. Server 104 may be any suitable computing device capable of maintaining a repository of information to be made available to other computing devices over computer communication network 100, such as a network-attached storage (NAS) device or other type of computer having storage capability. In some embodiments of the invention, server 104 may be dedicated exclusively to maintaining repository 104A, while in other embodiments of the invention, including examples described in greater detail below, the server 104 may be additionally adapted to perform functions related to malware scanning. Further, while server 104 is illustrated in FIG. 1 as a single computing device, in some embodiments of the invention server 104 may be implemented as a coordinated set of computing devices, sharing processing and/or storage loads.

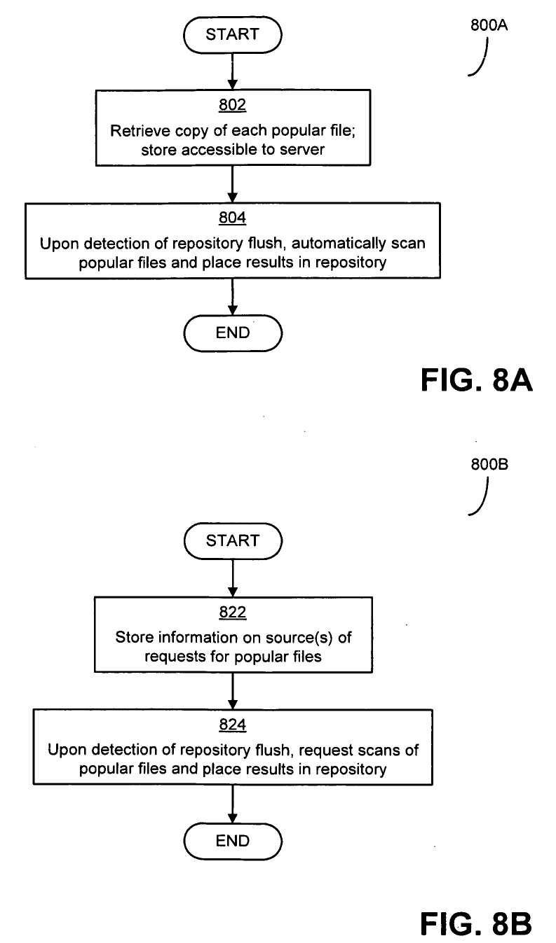

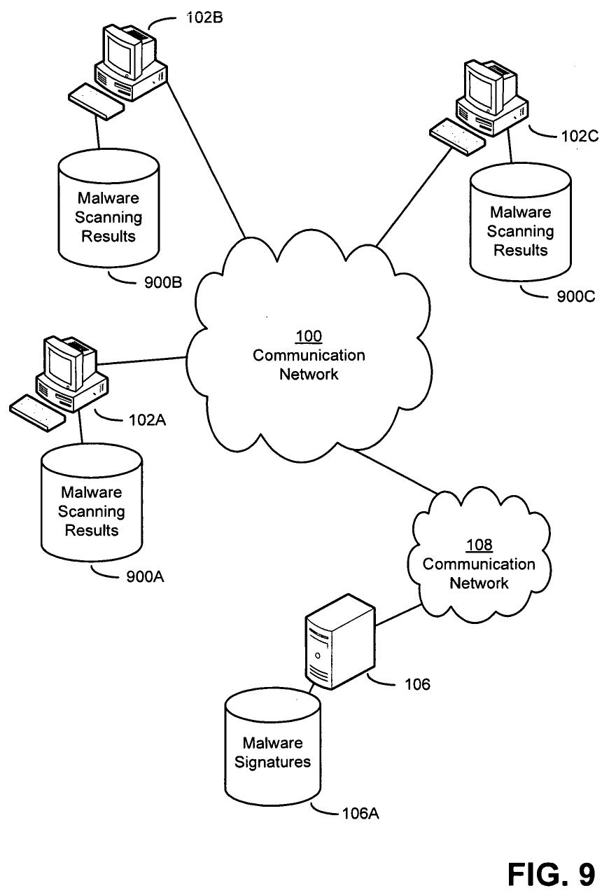

Further, while FIG. 1 shows the repository 104A maintained by a separate computing device server 104, in alternative embodiments of the invention, described in greater detail below with reference to FIG. 8, the repository may be maintained on one or more of the client computing devices 102.

In accordance with some embodiments, when a computing device 102 desires to determine whether a particular file includes malware, the computing device 102 may interact with server 104 to determine whether scan results for the file are stored in the repository 104A. Exemplary techniques for these interactions between the computing devices 102A, 102B, and 102C and the server 104 are described in greater detail below.

In general, the repository 104A of malware scanning results may be made available for access by computing device 102 to determine whether a particular file being accessed on a computing device 102 includes malware. As described briefly above and in greater detail below, the computing device 102 may derive a file signature (or other unique identifier) for the file, and provide the file signature to the server 104 to determine whether a result associated with the file is in the repository 104A. A file signature may be any information about a file that identifies the file, including information derived from the file itself. Thus, as used herein, the term file signature refers to any identifier for a file.

The information stored in repository 104A may comprise file signatures for one or more files and results from malware scans associated with those files. The scan results can be provided in any suitable way. In one embodiment, the scan results include results obtained from scans previously completed by a computing device 102, so that results are queried and shared by a community of users and computing devices. Repository 104A may be implemented as any suitable type of data store. In some embodiments, the repository 104A may be implemented as a database holding this information, such as a relational database, while in other embodiments the repository 104A may be implemented as a flat file in a file system, or as any other suitable data structure in a data store.

Communication network 100, to which each of these computing devices is connected, may be any suitable wired and/or wireless network, including a portion of a larger wired and/or wireless network. For example, in some implementations the communication network 100 may be or include a Local Area Network (LAN) in the home of a user of computing device 102, or may be or include a LAN or Wide Area Network (WAN) of an organization, such as a corporation, with which users of the computing devices 102A, 102B, and 102C are associated. In some such embodiments—where the communication network 100 is a single network “realm,” under control of a single entity such as a user or organization—the server 104 may limit access to the repository 104A to only those computing devices associated with the entity. This may be done to ensure that the results stored in repository 104A may be trusted, and are not illegitimate results contributed to the repository by a malicious party to aid that malicious party in distributing malware (e.g., by certifying, in the repository 104A, that the malware does not include malware).

In other embodiments, communication network 100 may not be a single network realm. Instead, communication network 100 may be a publicly-accessible network such as the Internet. In some such embodiments, server 104 may be maintained by a commercial entity, such as one offering a malware service to which users of the computing devices 102A, 102B, and 102C may subscribe to gain access to the repository 104A, which may maintain exclusive control over which scan result entries provided by a computing device 102 are included in the repository 104A. In other embodiments, server 104 may instead be maintained for open access to computing devices connected to the communication network 100, so that the user community may contribute scan result entries to the repository. In some such embodiments, where the server 104 is maintained by a commercial entity or is maintained for open access, the computing devices 102A, 102B, and 102C may be owned and maintained by different people and/or organizations and may, in some embodiments, have no relationship to one another beyond participation in the community sharing the repository 104A.

FIG. 1 also shows a second communication network 108, connected to communication network 100. Communication network 108 may be any suitable wired and/or wireless network. Connected to the communication network 108 is a server 106 having a data store 106A of malware definitions. The malware definitions may be any suitable sets of file characteristics that may be used by malware scanning software to determine whether a particular file includes malware. For example, a file characteristic may be a particular byte sequence that, if located within a file, indicates that malware is embedded in that file. Actions that are taken or will be taken when a file is accessed may also be used to characterize malware. For example, if a file writes, changes, or deletes particular files and/or configuration settings on a computing device, instantiates particular processes, opens network connection using particular servers and/or particular ports, or takes any other specific action, these actions may indicate that the file includes malware. Such determinations may be made by maintaining, as a part of the file characteristics, a list of actions that may be taken by a file. A file may then be analyzed to determine whether it takes any of the actions that are listed in the file characteristics. Further, a source of a file may be used as file characteristics or as a part of file characteristics. For example, the file characteristics may include exemplary sources of files, such as names and/or Internet Protocol (IP) addresses for servers that may host files, or a list of trusted and/or untrusted authorities for particular files that may be compared to files to determine whether the files come from a trusted source.

In some embodiments of the invention, the malware definitions may comprise a “black list” that provides information indicating whether files that match the file characteristics include malware. In other embodiments of the invention, the malware definitions may comprise a “white list” that provides information indicating whether files that match the file characteristics do not include malware. In other embodiments of the invention, the malware definitions may comprise both a white list and a black list. The server 106 may provide these malware definitions to other computing devices of the computer system shown in FIG. 1, such as computing devices 102A, 102B, and 102C and/or server 104, to perform malware scans.

It should be appreciated that the malware definition information stored in data store 106A is not the same information as the malware scanning results stored in repository 104A. The malware definitions of data store 106A provide information that may be useful in determining whether a file that is to be scanned contains malware. Each of these file characteristics in the malware definitions of data store 106A may apply to many different files. For example, malware such as a computer virus may be embedded in different files, such as a first image file depicting a person and a second image file depicting a landscape. These files are fundamentally different, as they contain, overall, different content (image data regarding a person and image data regarding a landscape). However, a file characteristic matching the computer virus may detect that both of these image files contain a particular computer virus by, for example, determining whether a particular byte sequence associated with the computer virus is present in both of the files. Accordingly, individual file characteristics, or sets of file characteristics, that are a part of the malware definitions of data store 106A may match a plurality of different files and be used to determine whether a given file includes malware. Repository 104A, on the other hand, stores file signatures that may identify a particular file, and an indication of whether that particular file was previously scanned—using malware definitions such as those stored in data store 106A—and whether that particular file was found during that scan to contain malware. File signatures cannot be used, by themselves, to determine whether a particular file contains malware. Instead, file signatures are only an identifier for a file.

While shown in FIG. 1 as a separate network, it should be appreciated that in some embodiments, communication network 108 may be part of the same network as communication network 100. This may be the case when communication network 100 is not a single network realm, such as where communication network 100 includes the Internet. However, in embodiments where communication network 100 is a single network realm, such as a home network or enterprise network, the communication network 108 may be a separate network outside of the single network realm, such as a publicly-accessible network (e.g., the Internet).

In some embodiments of the invention, a computing device 102 of FIG. 1 may have implemented thereon various software facilities to carry out tasks. One such facility may be a malware scanning facility that performs scans of particular files to determine whether they include malware. This malware scanning facility may be implemented in any suitable manner.

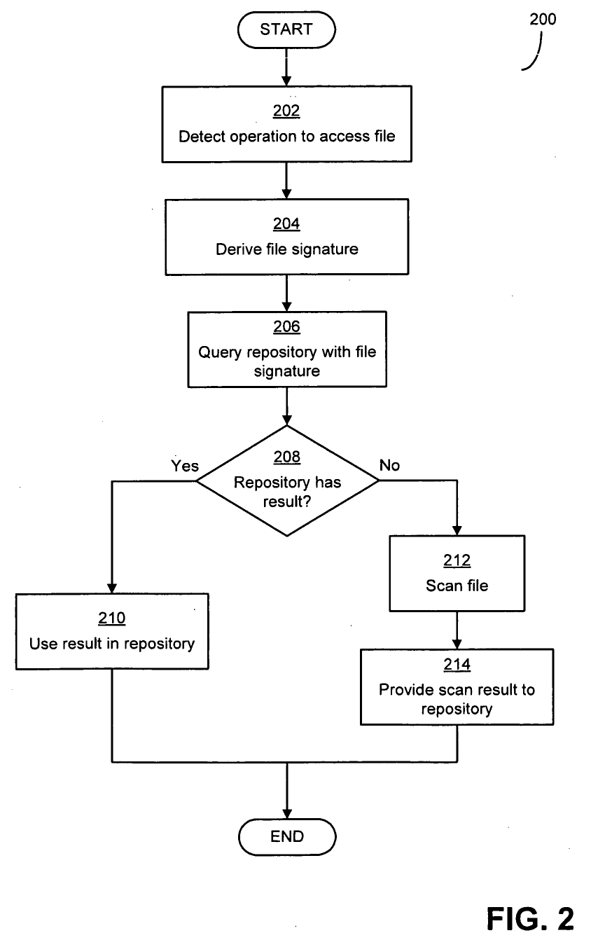

FIG. 2 shows one illustrative process 200 that may be implemented in a malware scanning facility in accordance with one embodiment of the invention. It should be appreciated, however, that process 200 is merely exemplary of the types of processes that may be implemented to carry out techniques described herein, and that others are possible. Further, while process 200 may be described with reference to the computer system of FIG. 1, it should be appreciated that the process 200 is not limited to operating in the exemplary computer system of FIG. 1, and that it may operate in any suitable computer system.

Process 200 begins in block 202, in which the malware scanning facility detects that a computer operation is to be performed to access a file. The computer operation accessing the file could be any suitable computer operation relating to the file, including executing the file, opening the file for read and/or write access, or any other operation. Further, the operation to access the file could be a specific command to the malware scanning facility to scan the file. The specific command could be based on input from a user, an operating system, or any other source of instructions on the computing device 102.

In block 204, the malware scanning facility derives a file signature for the file detected in block 202. A file signature, as discussed briefly above, may be any suitable identifier for a file, including a unique or probabilistically unique identifier (i.e., have a negligible or near-negligible likelihood of being a duplicate of another identifier). An identifier may also be “sufficiently” unique, in that the identifier is likely enough to be unique for a given environment or context that the identifier may be considered to be unique.

A file signature may comprise any data about the file, including immutable data. The file signature may be characteristic information about the file, such as a set of one or more file properties like a name of the file, a source of the file, size of the file, or other properties. A file signature additionally or alternatively may be information derived from the file, such as a hash value computed based on the contents of the file. A hash value is generated using any suitable hashing algorithm (e.g., MD5 or other) that is designed to generate a same value for identical content but a different value if the content is not identical. A file signature may additionally or alternatively be information within the file, such as contents of the file at a particular location within the file. As mentioned above, any suitable information that identifies a file, including information that identifies the file uniquely or otherwise, may be used as a signature. It should be appreciated that, as used herein, “unique” identifiers includes identifiers that are unique as well as identifiers that are probabilistically unique and sufficiently unique.

While conventional malware scanning software scans the file locally using malware definitions, or provides the file itself to an external computing device to perform the scan of the file, in block 206 the malware scanning facility queries the server 104 to determine whether the repository 104A stores any information about the file. The query transmitted to the server 104 may include any suitable information about the file and/or scan, including the file signature derived block 204, a version number of malware definitions maintained by the malware scanning facility (if any), a version number of malware scanning software maintained by the malware scanning facility (if any), and/or any other suitable information.

The information about the file stored in the repository 104A may comprise a result of a scan operation for the file that was previously carried out and provided to the repository 104A in any suitable manner. In one embodiment, the scan results may include results of scans performed by one or more of the computing devices 102. For example, if the computing device carrying out process 200 is computing device 102A, the repository 104A may store a result of a scanning operation performed on the file by computing device 102A or by either of computing devices 102B or 102C, and the repository 104A is queried for that result, if it exists. The query of block 206 may be carried out in any suitable manner, and any suitable information may be exchanged between computing device 102 and server 104 during the query.

Once the server 104 responds to the query, in block 208 the malware scanning facility determines whether the response indicates that the repository has any information on the file. If so, and the information includes a result of a previous scan operation for the file, then in block 210 the malware scanning facility obtains the result—either from the response from server 104 in response to the query (i.e., the response indicating that there was an entry for the file also includes scan results for the file), or by requesting the result from the server 104, or in any other suitable manner—and uses the result as the answer to the question of whether the file includes malware. The process 200 then ends, and the result of the process may be used in any suitable manner. For example, if the result indicates that the file includes malware, then the result may be provided to the user via any suitable user interface, and/or the operation to access the file may be blocked. If, however, the result indicates that the file does not include malware, the operation may be allowed.

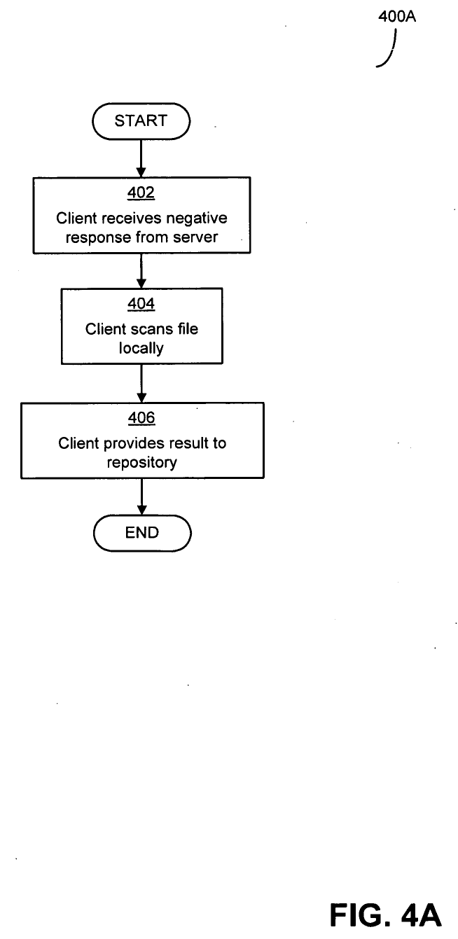

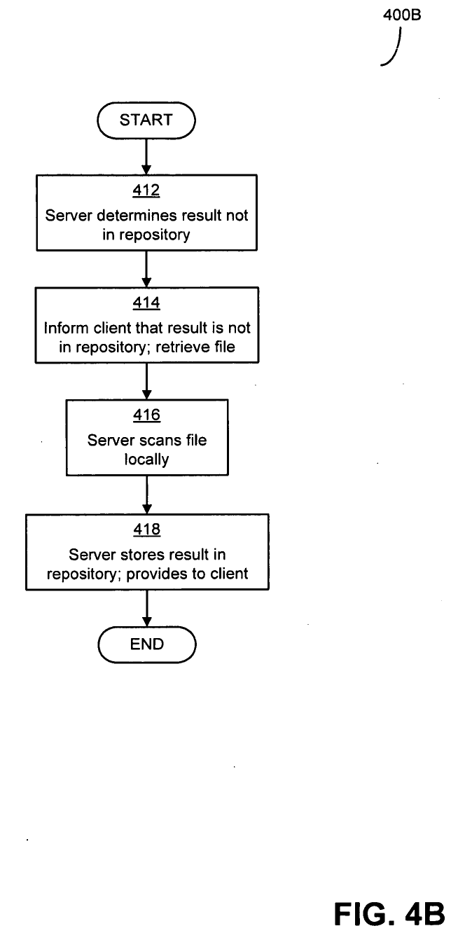

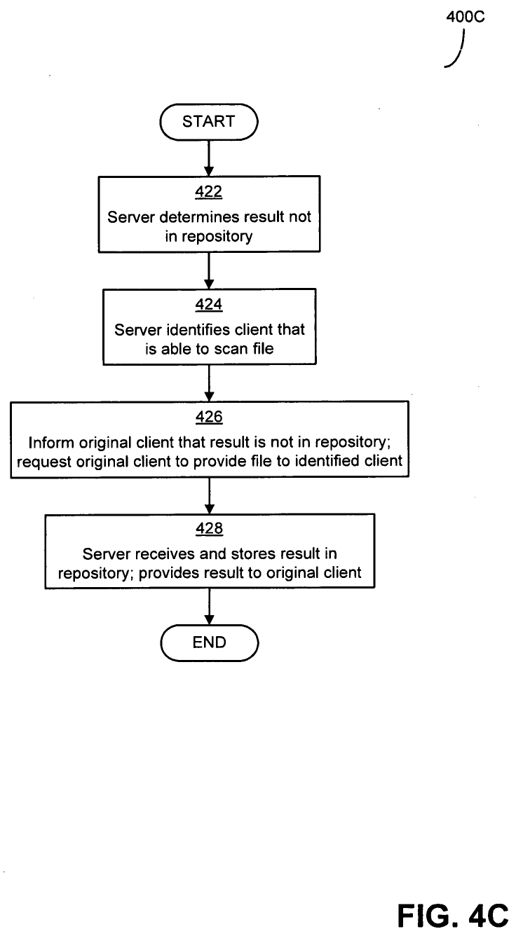

If the response from the server 104 in block 208 indicates that the repository 104 does not have any information on the file, or indicates that a result of a scanning operation is not among the information that it does have on the file, then in block 212 scan results for the file are obtained. The results may be obtained in any suitable manner, including according to any of the techniques below described in connection with FIGS. 4A, 4B, and 4C. For example, in embodiments where the malware scanning facility includes full functionality to scan files, the malware scanning facility on the computing device 102 may scan the file itself, using malware definitions stored local to the computing device 102. In other embodiments, the computing device receives scan results from elsewhere.

In block 214, once a result of the scan is derived—in any suitable manner—the result may be provided to the server 104 such that it may be placed in the repository 104A for use by other computing devices 102 when determining whether a particular file includes malware, and the process 200 ends. In some embodiments of the invention, upon being obtained, the result of the process 200—whether the file includes malware—may then be used in any suitable manner. For example, the result may be provided to a user via any suitable user interface, or stored in a local store of results. In some embodiments, provided the result to the user may comprise refraining from displaying one or more notifications to the user. For example, where an application program may be configured to notify a user of potential risk that may result from accessing a file (e.g., an e-mail client that notifies users that there is a malware risk associated with accessing executable files received via e-mail), the application program may be adapted to use the result obtained in one of blocks 210 and 212 to determine whether to display the notification. In this way, in embodiments of the invention that use a result in this manner, if a file is found not to include malware, the user may not be shown the notification regarding the potential risk. As another example, in some embodiments of the invention, if a scan result indicates that a file includes malware, the user may be notified of the malware and/or the operation to access the file may be disallowed or delayed until a user overrides the decision to disallow access.

In some embodiments, if a scan result indicates that a file contains malware, the file may be “cleaned” in any suitable manner, such as by removing the malware from the file or by replacing the file with a copy of the file known to the clean. This may be done in any suitable manner, including according to information supplied by malware definitions. For example, in some embodiments, if a file is determined not to include malware, then identifying information for the file may be supplied to the repository 104A such that if other copies of the file are determined to include malware, the clean version of the file may be supplied to replace the “infected” versions during a cleaning process. This identifying information supplied to the repository 104A may be any suitable information about the file, including file properties (e.g., title, minor and/or major version numbers, etc.), a portion of the file (e.g., a series of bytes at a particular location in the file), a digital signature for the file provided by a vendor/provider of the file identifying the file and/or its source, and/or any other information about the file. In some embodiments, the identifying information may be information that will remain static when a “clean” file becomes infected with malware, such that an underlying file (i.e., a file that was infected by malware to yield the file being cleaned) can be identified. It should be appreciated, however, that embodiments of the invention are not limited to using any particular type(s) of information to identify files to be cleaned, as embodiments of the invention are not limited in this respect.

In some embodiments, when this identifying information is provided to the repository 104A, the repository 104A may provide in response a “known good” version of the file from the repository and/or from another client computer 102 in the computer system. These known-good files may be copies of the underlying file that were determined not to contain malware, and may be used to “clean” the file that contains malware by replacing it with a good copy. Information on known-good copies of files may be maintained in any suitable manner. For example, the repository 104A may maintain information on known-good copies of files, such as which computing devices have copies of such files, or may itself maintain a data store of known-good copies of files. In some implementations, the data store of known-good files may be populated with some types of files, such as files relating to an operating system, and may be populated by computing devices and/or vendors associated with those files (e.g., vendors of operating systems), but it should be appreciated that any suitable information may be stored in the data store, and may be provided in any suitable manner.

A known-good file to be used as a replacement may be determined using the identifying information that was provided to the repository 104A in any suitable manner, such as by comparing the identifying information to properties of known-good files in the repository 104A or on other computing devices. If a known-good copy exists in the repository 104A or on another computing device, and is identified, a copy of the known-good file may then be provided to the computing device that requested it, and used to replace the infected file (i.e., the file determined to contain malware). In this way, in some embodiments of the invention, if a file is determined to contain malware, the malware may be removed by leveraging the community to provide a clean copy of the file, and a computing device may be enabled to use a file that had contained malware.

It should be appreciated, however, that not all embodiments may use a result of the process 200, or may not use a result that indicates that a file does not include malware, as embodiments of the invention are not limited to using a scan result in any particular manner.

As discussed above, processes like process 200 may be used to reduce the burden on computing devices when determining whether a particular file includes malware. By enabling a computing device to query a repository of previously-determined scan results, and rely on those previously-determined results, the computing device is freed from having to compute its own scan result each time a file is accessed, and lowers the processing burden for determining whether a file includes malware.

Server 104 of FIG. 1 may also have implemented thereon various software facilities to carry out tasks, and one such facility may be a repository facility that receives and handles queries to the repository 104A that seek to determine whether particular files include malware. This repository facility may be implemented in any suitable manner.

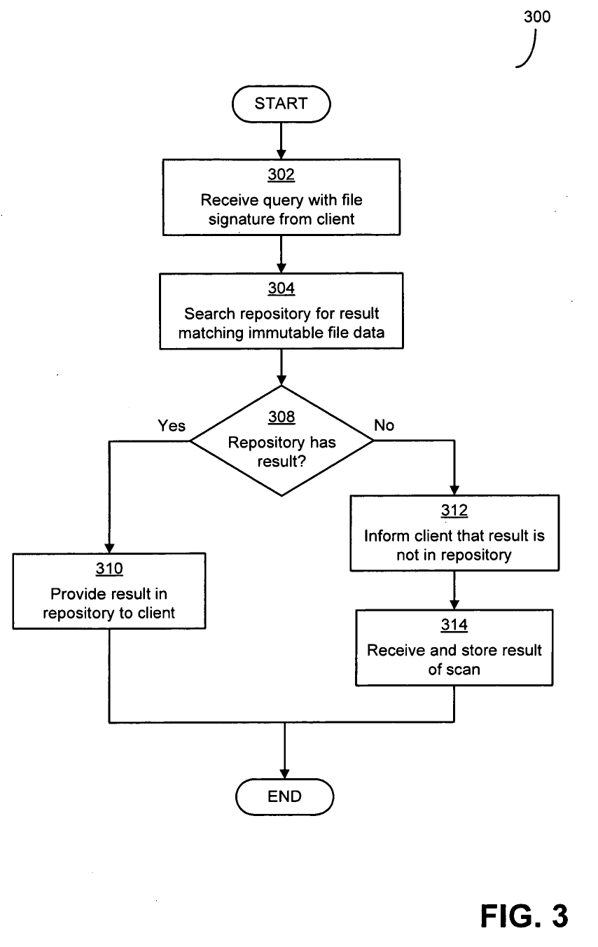

FIG. 3 shows one illustrative process 300 that may be implemented in a repository facility in accordance with one embodiment of the invention. It should be appreciated, however, that process 300 is merely exemplary of the types of processes that may be implemented to carry out techniques described herein, and that others are possible. Further, while process 300 is described with reference to the computer system of FIG. 1, it should be appreciated that the process 300 is not limited to operating in the exemplary computer system of FIG. 1, and that it may operate in any suitable computer system.

Process 300 begins in block 302, in which the repository facility receives a query from a computing device (such as computing device 102) with a file signature for a particular file, seeking a determination of whether the repository 104A contains information related to the particular file. In block 304, a search of the repository is commenced using the file signature provided in the query. This search may be carried out in any particular manner. For example, if the repository 104A comprises a table listing a plurality of file signatures, the file signature provided in the query may be compared to the plurality of file signatures in any suitable manner (e.g., using search algorithms such as binary search techniques) to determine whether there is a match. Because the file signature is information that may be used to uniquely identify a particular file, if there is a match between the file signature provided in the query and a file signature stored in the repository 104A, then the information stored in the repository 104A is information regarding the particular file being accessed by the computing device 102 issuing the query. If there is a match, it is determined whether the information stored in association with the file signature in the repository 104A comprises a result of a previous scanning operation for the file. For example, if the query of block 302 is from computing device 102A, the result stored in the repository 104A may be a result of a scanning operation performed previously by computing device 102A or another computing device such as device 102B.

If it is determined in block 308 that the repository 104A does include a result of a previous scanning operation for the file, then in block 310 that result is provided to the client by the repository facility. The result may be provided directly, in response to the query, or the repository facility may respond that it has the result and respond with the result to a follow-up query from the computing device 102 that issued the original query. The process 300 then ends.

If, however, it is determined in block 308 that the repository 104A does not include a result of a previous scanning operation for the file, then in block 312 the repository facility may respond to the computing device 102 that issued the query of block 302 that it does not have the result. The file may then be scanned in any suitable manner, including by any of the exemplary processes described below in connection with FIGS. 4A, 4B, and 4C. For example, in embodiments where the malware scanning facility of the client computing device includes full functionality to scan files, the malware scanning facility on the computing device 102 may scan the file itself, using malware definitions stored local to the computing device 102. In alternative embodiments, the scan may be performed by the server 104, or another computing device, as discussed below.

In block 314, once a result of the scan is derived—in any suitable manner—the repository facility receives the result and stores it in the repository 104A so that it may be used by any of the computing devices 102 when determining whether a particular file includes malware. The process 300 then ends.

If it is determined in either of blocks 208 or 308 of FIGS. 2 and 3, respectively, that the repository 104A does not include a result of a previous scanning operation for the file, then the file may be scanned in any suitable manner. In some embodiments, how and where a scan is performed may depend on how a computing device 102 that issues the query is implemented, along with other properties and characteristics of the system, as outlined below. Further, where the system includes multiple computing devices 102—such as computing devices 102A, 102B, and 102C of the exemplary computer system of FIG. 1—each of these computing devices may be implemented in a different manner and so may carry out scanning operations in a different manner. For example, a computing device 102A may be implemented as a desktop computer and be capable of performing malware scans locally, while computing device 102B may be implemented as a personal digital assistant (PDA) and not have the processing power or storage resources to carry out a scan locally and may instead depend on other computing devices in the computer system to carry out the scan to determine whether a particular file includes malware.

Accordingly, different processes may be implemented to carry out scans of particular files for different computing devices and/or different computer systems. FIGS. 4A, 4B, and 4C show three different exemplary processes that may be used to perform scans of files that do not have results stored in the repository 104A. It should be appreciated that these processes are merely illustrative of the types of processes that may be carried out to scan files, and that other processes are possible. Further, it should be appreciated that while these processes are described below as alternatives, in some embodiments of the invention two or more of these processes may be implemented in a particular computing device or computer system, and a selection between them may be made based on conditions at the time the processes are to be executed. For example, a decision may be made based on the resources available to a computing device 102 at the time the scan process is to be carried out, including the load other processes being performed by computing device 102 are placing on the processor or storage resources of computing device 102.

FIG. 4A shows one exemplary process for carrying out a scan of a particular file when the repository 104A does not have a result of a previous scanning operation for the file. The process 400A of FIG. 4A may be implemented by a computing device 102 that has a malware scanning facility including the full functionality to scan files.

Process 400A begins in block 402, in which the client computing device 102 receives a negative response from the server 104 indicating that the repository 104A does not include a result of a previous scanning operation. In block 404, the malware scanning facility of the computing device 102 performs the scan locally, using any suitable technique for scanning malware files. For example, the malware scanning facility may use malware definitions, such as those stored in data store 106A of FIG. 1, to determine whether the file contains malware. In block 406, the computing device 102 uses the result locally, and optionally provides the result of the scan operation of block 404 to the repository 104A. The process 400A then ends.

FIG. 4B shows another exemplary process 400B for carrying out a scan of a particular file when the repository 104A does not have a result of a previous scanning operation for the file. The process 400B of FIG. 4B may be implemented by the server 104 when the computing device 102 that issued the original query to the server 104 (e.g., the query of block 302 of FIG. 3) does not have a malware scanning facility including the full functionality to scan files. This may be because the computing device 102 does not have the resources to carry out a scan of a file, or for any other reason.

Process 400B begins in block 412, when the server 104 determines that the repository 104A does not store a result of a previous scanning operation for the file. In block 414, the server 104 responds to the client computing device 102 that the result is not in the repository 104A, and requests (explicitly or implicitly in systems when clients are configured to provide content to be scanned in response to receiving indications that no scan results exists already) that the computing device 102 provide the file to the server. In block 416, the server 104 receives the file and scans it locally, using malware scanning software on the server 104. This scan may be performed using any suitable technique for scanning malware files. For example, the malware scanning facility may use malware definitions, such as those stored in data store 106A of FIG. 1, to determine whether the file contains malware. In block 418, the result of the scan operation is stored in the repository 104A, and the result is provided to the client computing device 102. The process 400B then ends, and the contents of the file, received in block 416, may be deleted from the server 104.

FIG. 4C shows another exemplary process 400C for carrying out a scan of a particular file when the repository 104A does not have a result of a previous scanning operation for the file. The process 400C of FIG. 4C may be implemented by the server 104 when neither the server 104 nor the computing device 102 can scan the file, or for any other purpose (e.g., to distribute the load of scanning among a plurality of computers by offloading some or all of the scanning from the server). The determination that neither the server 104 nor the computing device 102 should perform the scan may be made if neither has malware scanning software capable of scanning the file, if neither the server 104 nor the computing device 102 has available resources to scan the file, or for any other reason or combination of reasons (e.g., the computing device 102 does not have the resources and the server 104 does not have the software). Alternatively, as discussed above, the determination may be based on techniques designed to distribute the burden of scanning and balancing the load of performing malware scans, which may be implemented in any suitable manner.

The process 400C of FIG. 4C begins in block 422, in which the server 104 determines that the repository 104A does not store a result of a previous scanning operation for the file. In block 414, the server 104 identifies another client computing device 102 that is able to scan the file. For example, if computing device 102A originally requested the scan and is unable to scan the file itself, computing device 102B may be identified as able to scan the file. In block 426, the server 104 responds to original client computing device 102A (i.e., the source of the original query), informs the computing device 102A that the repository 104A does not have a result of a previous scanning operation, and requests that the original client computing device 102A provide the file, either indirectly via the server or directly, to the client computing device (e.g., device 102B) identified in block 424 as able to carry out the scan. The original client computing device 102A may then provide the identified client computing device 102B and/or the server with the file in any suitable manner. A malware scanning facility of the identified client computing device 102B may then scan the file in any suitable manner, and in block 428 the requesting client (e.g., computing device 102A) and/or the server 104 receives the result of this scan. When the server 104 receives the scan results, it may store the result in the repository 104A. In addition, when the result is not provided directly to the original client computing device 102A (i.e., the source of the original query), the server may provide it.

Identifying a client computing device which is able to scan the file, in block 424, may be performed in any suitable manner. For example, the server 104 may store information identifying client computing devices that have the ability to scan files locally. The server 104, upon detecting a need to identify a computing device in block 424, may then select a computing device from the list of computing devices that have this ability. The selection may be made randomly, may be made using a round robin technique, may be made based on knowledge of the resources available to each of the computing devices at that time, or may be based on any suitable load balancing technique. For example, the server 104 may have knowledge of the processing and/or storage resources being used by loads currently placed on each of the computing devices, and may select a computing device that has the most available resources. When a selection is made based on available resources, any suitable selection technique may be used to make the selection. In other embodiments, the identification of block 424 may be based on characteristics of the file itself, or based on traffic on the communication network 100 at the time of the selection. For example, if the server 104 has knowledge that the file is large, or that the communication network 100 is congested at that time, then the server 104 may identify a computing device 102B that is geographically close to the original computing device 102A to limit transfer time for the file between the computing devices and limit impact on the network. As mentioned above, embodiments of the invention are not limited to selecting a computing device to perform the scan in any particular way.

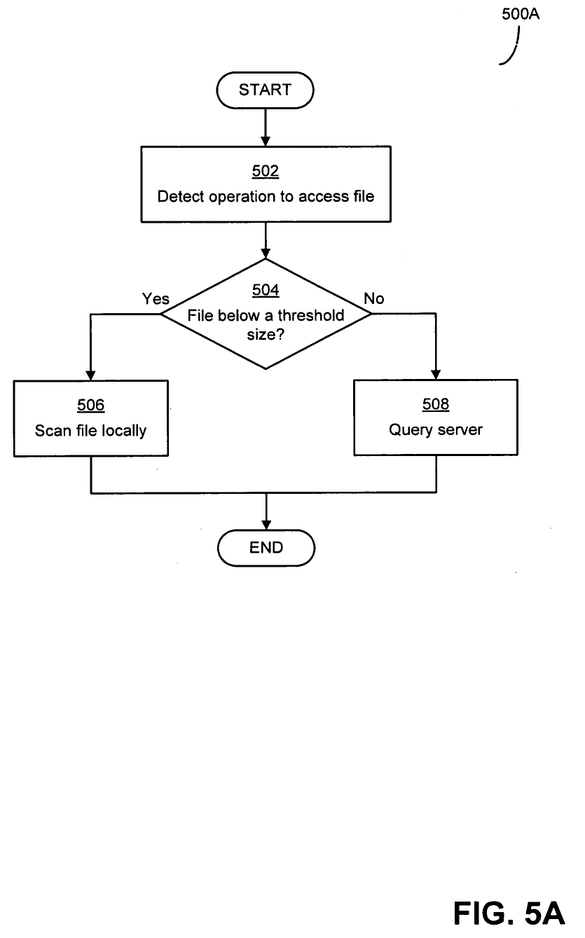

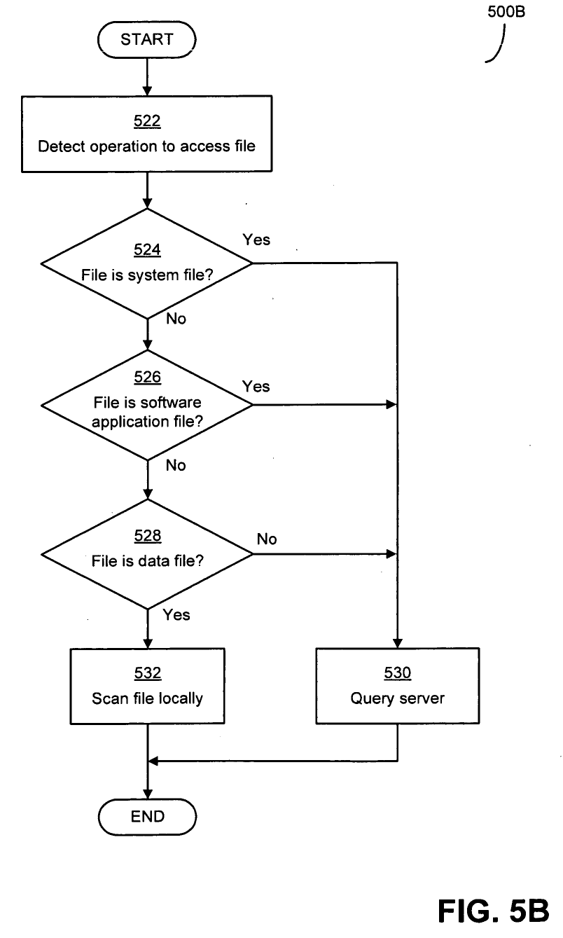

As shall be appreciated from the foregoing, in some embodiment, a malware scanning facility of a computing device 102 is adapted to perform a scan of a file locally and/or to query the server 104 to determine whether a repository 104A stores scan results. In some embodiments of the invention, such a malware scanning facility may determine whether to query the server 104 or perform the scan locally. This determination may be made in any suitable manner based on any suitable factors. FIGS. 5A and 5B show two such processes that may be implemented by a malware scanning facility to make this determination. It should be appreciated, however, that embodiments of the invention are not limited to implementing these processes, processes based on these factors, or any particular process for making this determination.

Process 500A of FIG. 5A begins in block 502, in which the malware scanning facility of a computing device 102 detects an operation to access a file. This may be done in any suitable manner for any suitable operation, as described above in connection with block 202 of FIG. 2. In block 504, the malware scanning facility may examine the file to determine whether to query the server 104 first, or to scan the file locally without querying the server 104. In the illustrative example of FIG. 5A, if the file is detected as being a size below a certain threshold-for example, 1 kilobyte (KB) or 1 megabyte (MB), or any other suitable threshold value-then in block 506 the file may be scanned locally without querying the server 104. This may be done because the resources necessary to scan the file are not large, so that any increase in efficiency gained from querying the server 104 would not be large and may be offset by the performance impact of communicating with the server 104. If, however, it is determined in block 504 that the file is above the threshold size, then in block 508 the server 104 may be queried in block 508 in the same manner as discussed above in connection with block 206 of FIG. 2. Following either of blocks 506 or 508, the process 500A ends.

FIG. 5B shows another process 500B that may additionally or alternatively be used to determine whether to query the server 104. Process 500B begins in block 522, in which the malware scanning facility of a computing device 102 detects an operation to access a file. This may be done in any suitable manner for any suitable operation, as described above in connection with block 202 of FIG. 2. In blocks 524 to 528, the malware scanning facility may then determine, based on the type of the file to be queried or scanned, whether to perform the query first or to scan the file locally without querying the server 104.

The decisions of blocks 524 to 528 may be made to determine whether the file is one which is likely to have a result stored in the repository 104A. If it is not likely that a result will be stored in the repository 104A, then the malware scanning facility may forego the query and scan the file locally. In block 524, it is determined whether the file is a system file. A system file may be any file that is related to a core component of the computing device 102 on which the malware scanning facility is executing, such as a file associated with an operating system of the computing device 102 (e.g., an operating system of the Microsoft Windows family, available from the Microsoft Corporation of Redmond, Wash.). It may be likely that other computing devices have the same or similar system files as computing device 102 (such as the same or similar operating system), and thus it may be likely that other computing devices have previously scanned a system file and placed the result in the repository 104A. Accordingly, if it is determined in block 524 that the file is a system file, then the server 104 may be queried in block 530.

If, however, it is determined in block 524 that the file is not a system file, then in block 526 it is determined whether the file is associated with a software application program. The application program may be any software application installed on the computing device 102 that enables the computing device to carry out a specific function. A word processing program such as Microsoft Word, available from the Microsoft Corporation, is one example of such an application program. It may be likely that other computing devices 102 have installed thereon the same or similar application programs as computing device 102, particular if the application program is popular and in widespread use, and thus it may be likely that other computing devices have previously scanned the file and placed the result in the repository 104A. Accordingly, if it is determined in block 526 that the file is an application file, then the server 104 may be queried in block 530. While not illustrated in FIG. 5B, in some embodiments of the invention that implement a process similar to process 500B, the decision of block 526 may also comprise a determination of whether the software application file is associated with a “popular” software application program. If the file is not associated with a popular application program, then it may be less likely that a result would be stored in the repository 104A, and thus the file may be scanned locally rather than querying the server 104 first. The determination of whether an application program is “popular” can be done in any way (e.g., by consulting a list).

If it is determined in block 526 that the file is not associated with a software application program, then in block 528 it is determined whether the file is a data file. Data files may be any files that include data content, such as data content generated by a user of a computing device, or by a process executing on a computing devices that may be associated with an application program or a system process. Files that store text, images, movies, audio, or other types of generated content may be data files. It may be likely that data files may not be in widespread use among different computing devices, such as when a data file was generated by a user of the computing device 102 on which the malware scanning facility is executing. Accordingly, if the data file is not in widespread use, then it may be unlikely that another computing device would have accessed that particular file and thus not likely that a result of a previous scan operation would be in the repository 104A. If a file is a data file, then in block 532, the file may be scanned locally by the malware scanning facility. While not illustrated in FIG. 5B, in some embodiments of the invention that implement a process similar to process 500B, the decision of block 528 may also comprise a determination of whether the data file is a “popular” data file. If the data file is popular—such as a file that different users are collaborating on, such as the users of computing devices 102A, 102B, and 102C—then it may be more likely that a result would be stored in the repository 104A, and thus the server 104 may be queried first. The determination of whether a data file is “popular” can be done in any way (e.g., by consulting a list of known popular data files, or by querying a user for popular data files).

If it is determined in block 528 that the file is not a data file, and thus is not one of the enumerated types of files, then in block 530, without information on whether it is likely that the result will be in the repository 104A, the process may default to querying the server 104 first, to attempt to achieve the gain in efficiency that may result from querying the server 104. In alternative embodiments of the invention, however, the default selection for a file of unknown type may be to perform the scan locally.

Once the file is scanned locally in block 532, or the server queried in block 530, the process 500B ends.

In some embodiments of the invention that implement a process similar to process 500A and/or process 500B, once a result of a scanning operation is obtained through local scanning in one of blocks 506 and 532, the result may be provided to the repository 104A in any suitable manner, such as by communicating the result to the server 104.

It should be appreciated that while the processes 500A and 500B of FIGS. 5A and 5B are described as alternatives, in some embodiments of the invention a process may be implemented that uses more than one factor, such as file type and file size, to determine whether to query the server 104 or perform a scan locally.

It should be further appreciated that not all embodiments of the invention are limited to performing a process to determine whether to query a server 104 or perform a scan locally, as in some embodiments of the invention a malware scanning facility of a computing device 102 may always query a server 104.

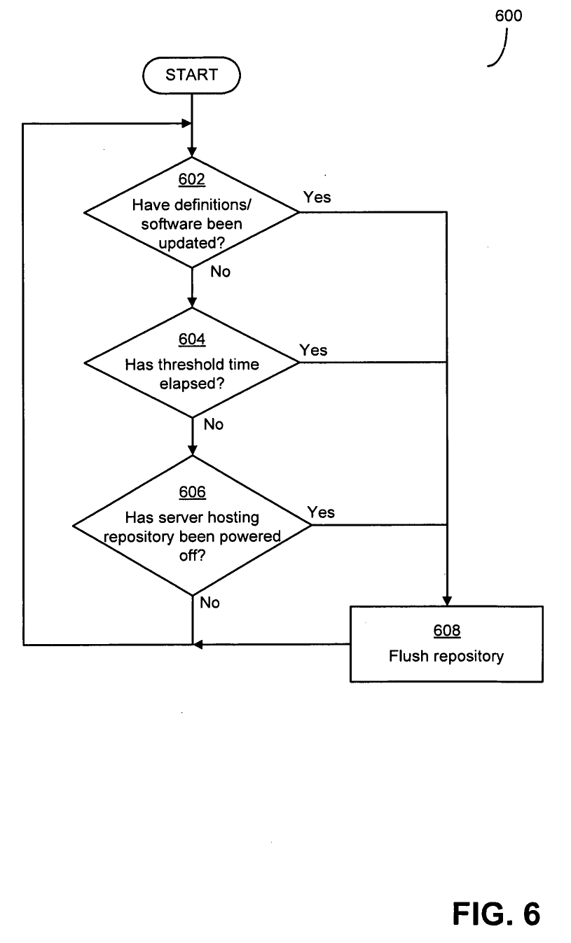

Techniques have been discussed above for contributing to and using a repository 104A of malware scanning results. In some embodiments of the invention, the repository 104A, once created, may continue to grow and be used perpetually. In other embodiments of the invention, however, the repository 104A may periodically be entirely or partially erased/flushed and rebuilt. This may be done for any suitable reason, examples of which are described below in connection with FIG. 6.

FIG. 6 shows an exemplary process 600 that may be implemented by a repository facility and carried out by a server 104 to periodically flush the repository 104A in part or in whole. It should be appreciated, however, that embodiments of the invention which do implement a process to periodically flush the repository 104A are not limited to carrying out the particular process 600 shown in FIG. 6, nor are they limited to carrying out a process that evaluates the same factors considered in the exemplary process 600. Any suitable process based on any suitable factor(s) may be used to determine whether and when to flush the repository 104A.

Process 600 begins in block 602, prior to which the repository 104A has been created, and possibly contributed to and used by computing devices 102. The repository 104A, therefore, may have one or more entries that are associated with files and indicate whether these files have been determined to include malware (i.e., the results). In block 602, it is determined whether the malware definitions and/or malware scanning software on which the results in the repository 104A were based have been updated. For example, if the malware definitions, such as the malware definitions stored in data store 106A of FIG. 1, have been updated, then those malware definitions may now identify more files as malware than before. It is possible, then, that a file that may have been previously determined not to include malware under the old definitions may be determined to include malware under the new definitions. This may be because a vendor that creates the malware definitions has recently discovered a computer virus or other malware that was infecting the file that had been previously determined not to include malware, and has updated the malware definitions to reflect that discovery. Accordingly, the results that were determined using the old definitions may no longer be reliable and should not be used. Likewise, if the malware scanning software implemented by a malware scanning facility to perform a scan has been updated to scan files in a different way—for example, to correct a defect or computer software bug in the method used to scan files—then it is possible that files that were determined using the old software not to include malware could now be determined to include malware. Accordingly, the results that were determined using the old software may no longer be reliable and should not be used.

Therefore, if it is determined in block 602 that the malware definitions and/or malware scanning software has been updated, then in block 608 the repository facility of server 104 may flush the repository 104A in whole or, in some embodiments of the invention, in part. Embodiments of the invention that only partially flush the repository 104A in part may flush any suitable part of the repository 104A, maintaining any other suitable part, and may base this determination on any suitable factors. For example, in some embodiments of the invention, this determination may be made based on the type of malware definitions that are used by the malware scanning software. As discussed above in connection with FIG. 1, malware definitions may comprise a “white list” and/or “black list” of file characteristics. A white list of file characteristics may be used to determine that files that match the file characteristics are do not include malware, while a black list of file characteristics may be used to determine that files that match the file characteristics include malware. When the repository 104A is to be flushed in part, the determination of which part to flush may be made under the assumption that these definitions have been expanded (i.e., more definitions added), not contracted (i.e., definitions removed). Accordingly, if a black list of file characteristics previously indicated that a file was malware, it is likely that the new black list of file characteristics will still indicate that that file includes malware. As such, when the malware definitions are a black list of file characteristics, results in the repository 104A that indicate that a file includes malware may still be reliable, and may be left in the repository 104A. Similarly, when the malware definitions are a white list of file characteristics that were confirmed to be good, results in the repository 104A that indicate that a file does not include malware may still be reliable, and may be left in the repository 104A. In this way, following a flush the repository 104A may still store some information that may be used by computing devices 102 in determining whether files include or do not include malware.

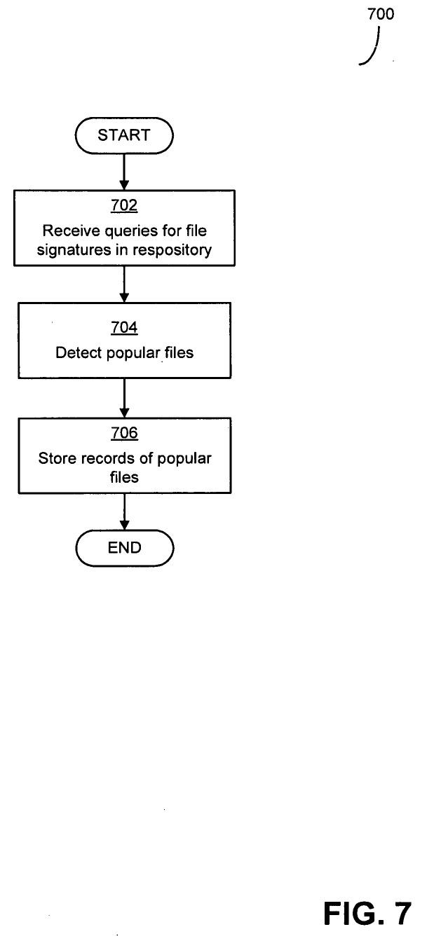

A flush of the repository in block 608 may be carried out in any suitable manner. In some embodiments of the invention, when an entry is flushed from the repository 104A all information associated with the entry may be removed from the repository 104A. In other embodiments of the invention, some information associated with an entry may be preserved in the repository 104A. Any suitable information may be preserved, examples of which are discussed below in connection with FIGS. 7A and 7B.

If it is determined in block 602 that the malware definitions and/or malware scanning software has not been updated, then in block 604 it is determined whether a threshold amount of time has passed since the repository 104A was last flushed. If the threshold time has passed, then the repository may be flushed in whole or in part in block 608. This threshold time may be used to ensure that the repository 104A does not become so large that it becomes inefficient to search (e.g., the number of entries is large enough that it would take, on average, so long to search for a particular entry that no increase in efficiency would be gained from the average search and the file should be scanned instead). As with the above discussion of partial flushing following an update to the malware definitions or scanning software, flushing the repository 104A in block 608 may be performed in whole or in part following a determination that a threshold time has passed. For example, all entries in the repository 104A may be flushed after the threshold time, or only entries that were created a threshold time in the past may be flushed such that recently-created entries are preserved, or only entries that were last accessed a threshold time in the past may be flushed such that files that were queried more often or more recently may be preserved. Any suitable time may be used as a threshold time. In one embodiment of the invention, the threshold time may be one week, but other time periods may be used.

If it is determined in block 604 that the threshold time had not elapsed, then in block 606, it is determined whether the server 104, hosting the repository 104A, has been powered off, such as during a shut down or restart. If the server 104 was powered off, it may be possible that an attacker could have tampered with the information stored in repository 104A during the shut down, such as by removing the storage media on which the repository 104A is stored from the server 104 and manipulating them using another computing device. To prevent this possibility, if it is determined in block 606 that the server 104 was powered off, then in block 608 the repository 104A may be flushed.

If, however, it is determined in block 608 that the server 104 was not powered off, then the process 600 returns to block 602 to continue monitoring for whether any of these conditions has been met.

Following a flush of the repository 104A, either in whole or in part, the repository 104A may be rebuilt by adding more entries to the repository 104A to ensure that the computing devices 102 see an increase in efficiency from being able to use results in the repository. In some embodiments of the invention, the server 104 and repository 104A may take a passive approach to repopulation, and wait for computing devices 102 to contribute results of malware scans of files.

In other embodiments of the invention, however, the server 104 and repository 104A may take a more active approach to rebuilding the repository 104A. In one embodiment, the server 104 may request each of the computing devices 102A, 102B, and 102C to rescan all of the files that the computing device had previously scanned and resubmit a result to the repository. In other embodiments of the invention, the server 104 may only request this automatic scanning for files indicated as popular.

FIGS. 8A and 8B show two exemplary processes that may be implemented by a repository facility of the server 104 for automatically repopulating the repository 104A following a flush. In these processes, only files that have been detected as popular are automatically scanned and results submitted to the repository 104A. A popular file may be one that has been queried in the repository 104 a threshold number of times. This threshold number may only be based on a number of times a file has been queried—for example, that all files queried more than ten times are popular—or may be based on any suitable additional or alternative factors. For example, a detection of popularity may also have a time component; for example, that files that were at some time queried more than 10 times in one day are popular, or that files that were queried more than 10 times in the past day are popular. Any suitable determination may be made to decide which files are popular and whether a particular file is popular.

When a file is detected to be popular, then the file may be marked as such in the repository 104A by the repository facility, and this information may be used following a flush. Processes 800A and 800B show two exemplary ways in which information regarding popular files could be used following a flush to repopulate a repository, though others are possible.

This information regarding popular files may be determined and stored in any suitable manner. For example, in some embodiments of the invention, determinations of which files are popular may be made in response to queries made to the repository 104A to determine whether the repository 104A includes entries regarding the files. FIG. 7 shows a process 700 that may be used to determine which files are popular based on queries received by the repository 104A, but it should be appreciated that this process is merely illustrative and that others are possible.

Process 700 of FIG. 7 begins in block 702, in which a repository facility of the server 104 receives queries for entries in the repository 104A regarding particular files, and responds accordingly, including in any of the ways described above. In block 704, the repository facility detects, using any suitable technique, when a file is popular. For example, the repository facility may maintain a record of each query received from a computing device, and the file with which the query is associated (i.e., the queried file). If the record indicates that a file has been queried a threshold number of time (e.g., ten times), then the file may be marked as popular in block 706, and the process 700 ends.

FIG. 8A shows an illustrative process 800A that may make use of information regarding popular files (including information created and stored by a process such as a process 700 of FIG. 7) to rebuild a repository after a flush. Process 800A begins in block 802, in which a file, marked as popular, is retrieved from one of the computing devices that queried the repository 104A for the file, and stored at a location accessible to the server 104. For example, the file may be stored locally, or on a network data store accessible to the server 104.

In block 804, when the repository facility detects that the repository 104A has been flushed, popular files (stored accessible to the repository facility) may be automatically scanned and the results placed in the repository 104A. The scan of block 804 may be performed in any suitable manner. In some embodiments, the server 104 may scan all of the popular files itself, using the copies of the files stored accessible to the server 104. In other embodiments, the task of scanning all popular files may be distributed, such that at least some of the files are provided to other computing devices 102 to be scanned and the results provided to the repository 104A. Once the popular files have been scanned and results placed in the repository 104A, the process 800A ends. Automatically scanning files in this way ensures that results associated with files that can be expected to be queried—because they are popular files—are placed into the repository as quickly as possible so that they are in the repository when queried.

FIG. 8B shows an alternative process 800B for repopulating the repository 104A following a flush, that may be implemented by the repository facility in some embodiments of the invention. Process 800B begins in block 822, in which when a file is marked as popular (such as in block 706 of FIG. 7), the entry in the repository 104A may also be updated to identify at least one source of a query for the file, and thus at least one computing device 102 that has a copy of the file. The information identifying at least one source of the query may be any suitable information to identify a computing device, including an Internet Protocol (IP) Address or computer name such as a domain name.

In block 824, when the repository facility detects that the repository 104A has been flushed, the popular files may be automatically scanned and the results placed in the repository 104A. The scan of block 824 may be performed in any suitable manner. For example, the repository facility may then issue an instruction to one or more of the identified sources of the queries for the file to scan the file and place the result in the repository. The computing devices 102 that were the sources of the queries may then scan the files and place the results in the repository 104A. Once the popular files have been scanned and results placed in the repository 104A, the process 800B ends. Automatically scanning files in this way ensures that results associated with files that can be expected to be queried—because they are popular files—are placed into the repository as quickly as possible so that they are in the repository when queried.

It should be appreciated that processes 800A and 800B of FIGS. 8A and 8B are merely illustrative of the types of processes that may be implemented in embodiments of the invention that rebuild a repository after a flush using information regarding popular files. Embodiments of the invention that rebuild a repository are not limited to rebuilding the repository in any particular manner, nor are they limited to rebuilding the repository based on popularity of files. It should be appreciated further that not all embodiments of the invention may rebuild a repository automatically after a flush, as embodiments of the invention are not limited in this manner.

The exemplary techniques and processes described above for carrying out the principles described herein for increasing efficiency of malware scanning through enabling computing devices to make use of results previous determined by other computing devices have been described with reference to the exemplary computer system of FIG. 1. However, as discussed above, embodiments of the invention are not limited to operating in the exemplary computing system of FIG. 1, and may be implemented in any suitable computer system.

FIG. 9 shows one such computer system that is an alternative to the computer system shown in FIG. 1. Elements of FIG. 9 which are the same as or similar to elements of FIG. 1 have been labeled with the same numbers. As shown in FIG. 9, rather than the computer system comprising a repository 104A maintained by a server 104, a repository is hosted in a distributed fashion as repositories 900A, 900B, and 900C at each of computing devices 102A, 102B, and 102C. Each of the repositories 900A, 900B, and 900C may hold a portion of the repository, or may hold a complete copy of the repository that may be kept in synchronization with other copies of the repository using any suitable synchronization or replication technique. Querying the repositories 900A, 900B, and 900C may be performed in any suitable way, including by querying the copy of the repository local to a computing device 102, querying a particular repository that stores information related to the type of file for which a computing device 102 is searching, or querying all repositories. In computer systems such as the one shown in FIG. 9, tasks described above as being carried out by a repository facility on the server 104 may be carried out on one or more of the computing devices 102.

It should be appreciated that other alternative computer systems are also possible, as embodiments of the invention are not limited to operating in any particular computer system.

Various embodiments of the invention have been described above performing techniques that enable computing devices to make use of results previously determined by other computing devices to increase the overall efficiency of scanning for unauthorized software, and/or provide benefits of authorization scanning to devices incapable of performing such scans themselves. Some techniques described above relate to processes that may be carried out on a client computing device desiring to perform a scan of a file to determine whether the file is or is not authorized. These processes performed by the client may include querying a shared repository of authorization determinations prior to performing a scan locally. Other techniques described above relate to processes for maintaining a shared repository of authorization determinations, including by storing entries that include unique identifiers for particular files and indications of whether those particular files were previously determined to be authorized. Other techniques relate to processes for repopulating a repository following a flush of the repository, including by automatically scanning popular files to determine whether they are authorized (e.g., include malware) and placing results of those scans in the repository.

Embodiments of the invention are not limited to performing any or all of these techniques. Some embodiments of the invention may implement one of these techniques, while other embodiments of the invention may implement two, three, or more of these techniques. Embodiments of the invention may be implemented in any suitable manner to carry out any suitable functions relating to malware scanning.

Techniques operating according to the principles described herein may be implemented in any suitable manner. Included in the discussion above are a series of flow charts showing the steps and acts of various processes that enable these techniques. The processing and decision blocks of the flow charts above represent steps and acts that may be included in algorithms that carry out these various processes. Algorithms derived from these processes may be implemented as software integrated with and directing the operation of one or more dedicated or multi-purpose processors. Further, while some of these processes may have been described above in connection with particular embodiments of the invention implemented in software, the processes may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit, or of any particular programming language or type of programming language. Rather, the flow charts illustrate the functional information one of ordinary skill in the art may use to fabricate circuits or to implement computer software algorithms to perform the processing required of a particular apparatus carrying out the types of processes described herein. It should also be appreciated that unless otherwise indicated herein, the particular sequence of steps and acts described is merely illustrative and can be varied in implementations and embodiments of the principles described herein without departing from the invention.

Accordingly, in some embodiments, the techniques described herein may be embodied in computer-executable instructions implemented as software, including as application software, system software, firmware, middleware, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, as a discrete process, or as any other suitable unit of processing. If techniques described herein are implemented as multiple functional facilities, each functional facility may be implemented in its own way; all need not be implemented the same way. Additionally, these functional facilities may be executed in parallel or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package, for example as a software program application such as a stand-alone authorization scanning application. These functional facilities may, in alternative embodiments, be adapted to interact with other, unrelated functional facilities and/or processes, to implement a software program application such as a malware scanning application. In other implementations, the functional facilities may be adapted to interact with other functional facilities in such a way as form an operating system, including the Microsoft Windows operating system, available from the Microsoft Corporation of Redmond, Wash. In other words, in some implementations, the functional facilities may be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that may implement the exemplary techniques described herein, and that the invention is not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

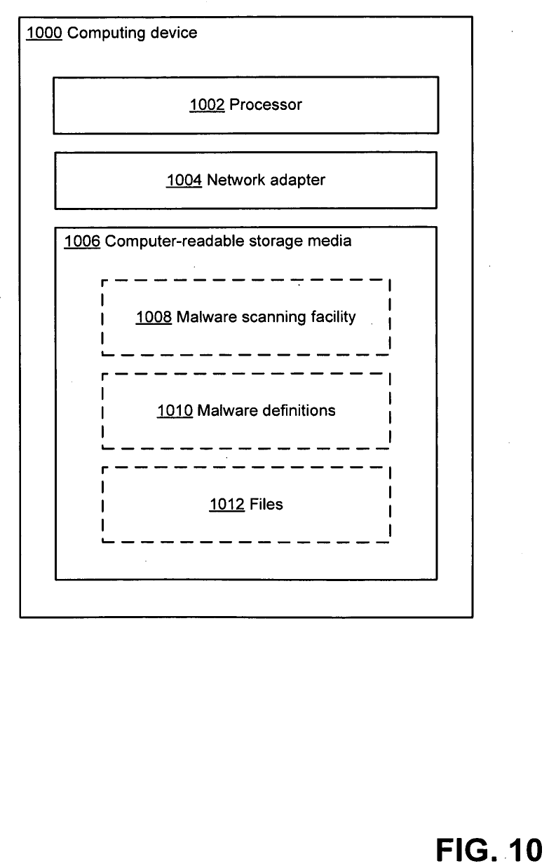

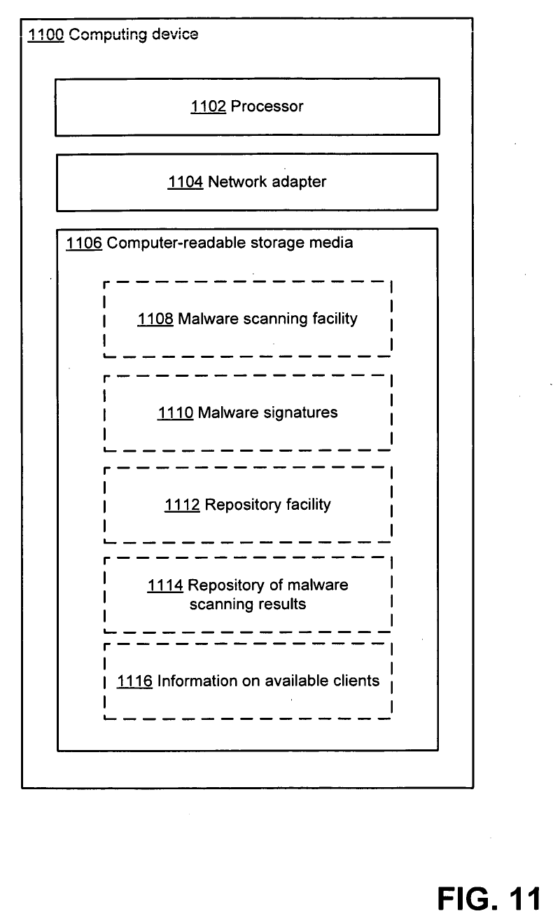

Computer-executable instructions implementing the techniques described herein (when implemented as one or more functional facilities or in any other manner) may, in some embodiments, be encoded on one or more computer-readable storage media to provide functionality to the storage media. These media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable storage medium may be implemented as computer-readable storage media 1006 or 1106 of FIGS. 10 and 11 described below (i.e., as a portion of a computing devices 1000 or 1100) or as a stand-alone, separate storage medium. It should be appreciated that, as used herein, a “computer-readable medium,” including “computer-readable storage medium,” refers to tangible storage media having at least one physical property that may be altered in some way during a process of recording data thereon. For example, a magnetization state of a portion of a physical structure of a computer-readable medium may be altered during a recording process.

Further, some techniques described above comprise acts of storing information (e.g., data and/or instructions) in certain ways for use by the techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, including the exemplary computer systems of FIGS. 1 and 8. Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 10 illustrates one exemplary implementation of a computing device in the form of a computing device 1000 that may be used in a system implementing the techniques described herein, although others are possible. Computing device 1000 of FIG. 10 may be implemented as a client computing device 102 in some embodiments of the invention. It should be appreciated that FIG. 10 is intended neither to be a depiction of necessary components for a computing device to operate in accordance with the principles described herein, nor a comprehensive depiction.

Computing device 1000 may comprise at least one processor 1002, a network adapter 1004, and computer-readable storage media 1006. Computing device 1000 may be, for example, a desktop or laptop personal computer, a personal digital assistant (PDA), a smart mobile phone, a server, a wireless access point or other networking element, or any other suitable computing device. Network adapter 1004 may be any suitable hardware and/or software to enable the computing device 1000 to communicate over a wire and/or wirelessly with any other suitable computing device over any suitable computing network. The computing network may include a wireless access point as well as any suitable wired and/or wireless communication medium or media for exchanging data between two or more computers, including the Internet. Computer-readable media 1006 may be adapted to store data to be processed and/or instructions to be executed by processor 1002. Processor 1002 enables processing of data and execution of instructions. The data and instructions may be stored on the computer-readable storage media 1006 and may, for example, enable communication between components of the computing device 1000.

The data and instructions stored on computer-readable storage media 1006 may comprise computer-executable instructions implementing techniques which operate according to the principles described herein. In the example of FIG. 10, computer-readable storage media 1006 stores computer-executable instructions implementing various facilities and storing various information as described above. Computer-readable storage media 1006 may store a malware scanning facility 1008 to determine whether to query a repository as part of scanning a file, to derive a file signature with which to query a repository, to query the repository, and/or to scan the file itself. Computer-readable storage media 1006 may also store malware definitions 1010 that may be used by malware scanning facility 1008 to scan files. Lastly, computer-readable storage media 1006 may also store one or more files 1012 to be scanned and accessed. In other embodiments of the invention, that operate to determine whether files are or include types of unauthorized software other than malware, appropriate facilities and information may be encoded on computer-readable storage media 1006 (e.g., an authorization scanning facility).

FIG. 11 illustrates one exemplary implementation of a computing device in the form of a computing device 1100 that may be used in a system implementing the techniques described herein, although others are possible. Computing device 1100 of FIG. 11 may be implemented as a server 104 in some embodiments of the invention. It should be appreciated that FIG. 11 is intended neither to be a depiction of necessary components for a computing device to operate in accordance with the principles described herein, nor a comprehensive depiction.

Computing device 1100 may comprise at least one processor 1102, a network adapter 1004, and computer-readable storage media 1106. Computing device 1100 may be, for example, a desktop or laptop personal computer, a server, a mainframe, or any other suitable computing device. Network adapter 1104 may be any suitable hardware and/or software to enable the computing device 1100 to communicate over a wire and/or wirelessly with any other suitable computing device over any suitable computing network. The computing network may include a wireless access point as well as any suitable wired and/or wireless communication medium or media for exchanging data between two or more computers, including the Internet. Computer-readable media 1106 may be adapted to store data to be processed and/or instructions to be executed by processor 1102. Processor 1102 enables processing of data and execution of instructions. The data and instructions may be stored on the computer-readable storage media 1106 and may, for example, enable communication between components of the computing device 1100.

The data and instructions stored on computer-readable storage media 1106 may comprise computer-executable instructions implementing techniques which operate according to the principles described herein. In the example of FIG. 11, computer-readable storage media 1106 stores computer-executable instructions implementing various facilities and storing various information as described above. Computer-readable storage media 1106 may store a malware scanning facility 1108 to scan files that have been provided to it, and malware definitions 1110 that may be used by the malware scanning facility 1108 to scan files. A repository facility 1112 may also be stored on computer-readable storage media 1106 and may maintain a repository of malware scanning results by responding to queries from client computing devices for the results, placing received results in the repository, and flushing the repository when necessary. Computer-readable storage media 1106 may also store a repository 1114 of malware scanning results, and information 1116 on available client computing devices that may be used to identify client computing devices to scan files when needed. In other embodiments of the invention, that operate to determine whether files are or include types of unauthorized software other than malware, appropriate facilities and information may be encoded on computer-readable storage media 1106 (e.g., an authorization scanning facility).

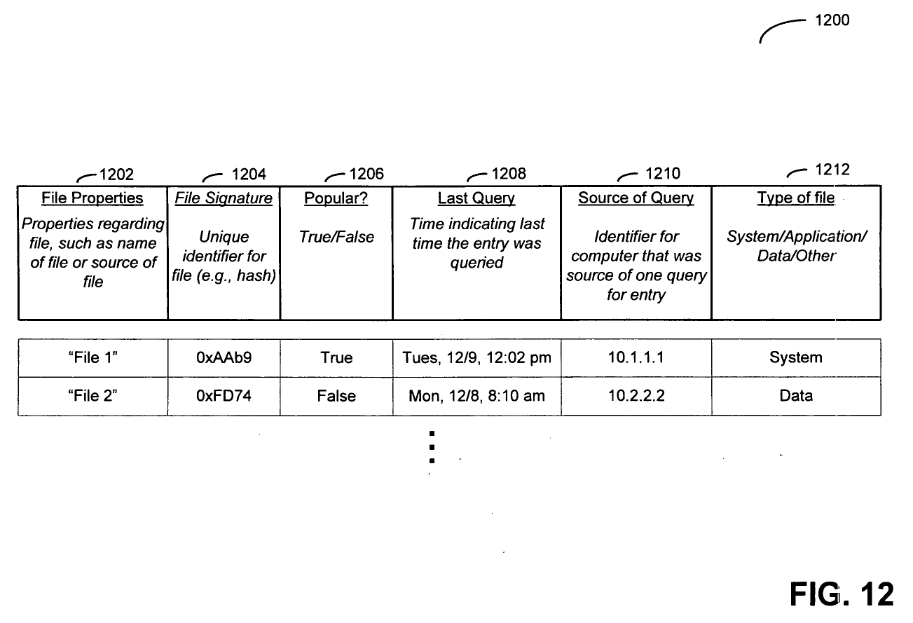

The repository 1214 of malware scanning results may be implemented in embodiments of the invention that perform scanning for malware to store, in any suitable manner, information about a file. FIG. 12 shows one exemplary table of information 1200 that may be stored on a computer-readable storage media 1106 and used to implement a repository 1114. The information shown in table 1200 may be stored in any suitable data structure, including in a database or flat file. It should be appreciated, however, that the data and fields shown in the exemplary table 1200 are merely illustrative of the types of fields and types of data which may be stored therein, and that embodiments of the invention are not limited to implementing a repository in any particular manner to store any particular information or type of information.

While not illustrated in FIGS. 10 and 11, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments of the invention have been described where the techniques are implemented in circuitry and/or computer-executable instructions. It should be appreciated that the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be within the spirit and scope of the invention. Accordingly, the foregoing description and drawings are by way of example only.

What is claimed is:

1. A method for making a determination of whether a particular content unit to be accessed in a computer system contains unauthorized software, the computer system comprising at least two client computing devices and a shared repository of authorization determinations, the shared repository of authorization determinations being accessible to each of the at least two client computing devices and comprising results of authorization determinations, each authorization determination being a determination of whether a corresponding content unit contains unauthorized software, at least some of the authorization determinations having been made by one or more of the at least two client computing devices, the method comprising:
(A) providing a unique identifier for the particular content unit to the shared repository of authorization determinations;
(B) receiving an indication of whether the shared repository includes an authorization determination for the particular content unit; and
(C) if the shared repository includes an authorization determination for the particular content unit, using the authorization determination in the shared repository to inform access to the particular content unit.

2. The method of claim 1, further comprising:
(D) if the shared repository does not store an authorization determination for the particular content unit, determining whether the particular content unit contains unauthorized software.

3. The method of claim 2, wherein the acts (A) to (D) are performed by a first client computing device among the at least two client computing devices, and wherein determining whether the particular content unit contains unauthorized software in act (D) comprises:
(D1) providing the particular content unit to at least one computing device other than the first client computing device to determine whether the particular content unit contains unauthorized software.

4. The method of claim 3, wherein the at least one computing device other than the first client computing device includes a server that maintains the shared repository of authorization determinations.

5. The method of claim 2, further comprising:
(D) updating the shared repository with the result of the determination of act (D).

6. The method of claim 1, wherein the method is performed in response to detecting an operation to access the particular content unit, and wherein the method further comprises:
(D) if the shared repository includes an authorization determination indicating that the particular content unit contains unauthorized software, notifying a user of the existence of the unauthorized software and/or disallowing the operation.

7. The method of claim 1, further comprising:
(D) prior to the act (A) of providing the unique identifier to the shared repository, determining at a first client computing device among the at least two client computing devices whether the file meets at least one condition, and if the file meets the at least one condition, determining locally at the first client computing device whether the particular file contains unauthorized software and refraining from accessing the shared repository in acts (A)-(C).

8. The method of claim 1, wherein the acts (A) to (D) are performed by a first client computing device among the at least two client computing devices, and wherein the method further comprises:
(D) if the particular content unit is determined to contain unauthorized software, requesting a known-good copy of the particular content unit from at least one computing device other than the first client computing device; and
(E) if a known-good copy of the particular content unit is received in response to the request of act (D), replacing the particular content unit with the known-good copy of the particular content unit.

9. The method of claim 1, wherein making the determination of whether a particular content unit to be accessed in a computer system contains unauthorized software comprises determining whether the particular content unit contains malware.

10. At least one computer-readable medium encoded with computer-executable instructions that, when executed by a computer, cause the computer to carry out a method for making a determination of whether a particular file to be accessed in a computer system contains malicious software, the computer system comprising at least two client computing devices and a shared repository of malware determinations, the shared repository of malware determinations being accessible to each of the at least two client computing devices and comprising results of malware determinations, each malware determination being a determination of whether a corresponding file contains malicious software, at least some of the malware determinations having been made by one or more of the at least two client computing devices, the method comprising:
(A) providing a unique identifier for the particular file to the shared repository of malware determination results;
(B) receiving an indication of whether the shared repository includes a malware determination for the particular file;
(C) if the shared repository includes a malware determination for the particular file, using the malware determination in the shared repository to inform access to the particular file; and
(D) if the shared repository does not include a malware determination,
(D1) determining whether the particular file contains malicious software; and
(D2) updating the shared repository with a result of the determining in act (D1).

11. The at least one computer-readable medium of claim 10, wherein the acts (A) to (D) are performed by a first client computing device among the at least two client computing devices, and wherein determining whether the particular content unit contains malicious software in act (D) comprises:
(D1) providing the particular content unit to at least one computing device other than the first client computing device to determine whether the particular content unit contains malicious software.

12. The at least one computer-readable medium of claim 11, wherein the at least one other computing device includes a server that maintains the shared repository of malware determination results.

13. The at least one computer-readable medium of claim 10, wherein the method is performed in response to detecting an operation to access the particular file, and the method further comprises:
(E) if the shared repository includes a malware determination indicating that the particular file contains malicious software, notifying a user of the existence of the malicious software and/or disallowing the operation.

14. The at least one computer-readable medium of claim 10, wherein the method further comprises:
(E) prior to the act (A) of providing the unique identifier to the shared repository, determining at a first client computing device among the at least two client computing devices whether the file meets at least one condition, and if the file meets the at least one condition, determining locally at the first client computing device whether the particular file contains malicious software and refraining from accessing the shared repository in acts (A)-(C).

15. The at least one computer-readable medium of claim 10, further comprising:
(E) providing a copy of the file to the shared repository of malware determinations in response to a request, from the shared repository, indicating that malware determination associated with the file in the shared repository has been accessed a threshold number of times.

16. A first client computing device for use in a computer system comprising the first client computer, at least one second client computing devices and a shared repository of authorization determinations, the shared repository of authorization determinations being accessible to each of the at least two client computing devices and comprising results of authorization determinations, each authorization determination being a determination of whether a corresponding content unit contains unauthorized software, at least some of the authorization determinations having been made by one or more of the at least two client computing devices, the first client computing device comprising:
at least one processor adapted to make a determination of whether a particular content unit to be accessed in the computer system contains unauthorized software by:
providing a unique identifier for the particular content unit to the shared repository of authorization determinations;
receiving an indication of whether the shared repository includes an authorization determination for the particular content unit; and
if the shared repository includes an authorization determination for the particular content unit, using the authorization determination in the shared repository to inform access to the particular content unit.

17. The apparatus of claim 16, wherein the at least one processor is further adapted to:
if the shared repository does not store an authorization determination for the particular content unit, determine whether the particular content unit contains unauthorized software.

18. The apparatus of claim 17, wherein determining whether the particular content unit contains unauthorized software comprises:
providing the particular content unit to at least one computing device other than the first client computing device to determine whether the particular content unit contains unauthorized software.

19. The apparatus of claim 18, wherein the at least one computing device other than the first client computing device includes a server that maintains the shared repository of authorization determinations.

20. The apparatus of claim 16, wherein the apparatus and the shared repository of authorization determinations are both connected to a network that is a single network realm.
